(19) United States
(12) Patent Application Publication
(10) Pub. No.: US 2004/0258437 A1
(43) Pub. Date: Dec. 23, 2004

(54) Image information detection sensor

(75) Inventors: Toshihumi Kakutani, Ibaraki (JP); Hajime Kaji, Chiba (JP); Tatsuhito Kataoka, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/820,126

(22) Filed: Apr. 8, 2004

(30) Foreign Application Priority Data
Apr. 16, 2003 (JP) 2003-111691

(51) Int. Cl. G03G 15/01

(52) U.S. Cl. 399/301

(57) ABSTRACT

An image information detection sensor includes a light-emitting element, a light-emitting pinhole which focuses light from the light-emitting element as detection light into a toner image detection region without using any lens, a light-receiving pinhole which transmits detection light reflected in the toner image detection region, and a light-receiving element which receives detection light having passed through the light-receiving pinhole. The spot diameter of an LED is reduced by minimizing the hole diameter of the light-emitting pinhole as far as a sufficient detection level can be obtained. The hole diameter of the light-receiving pinhole is set larger than that on the light-emitting side so as to receive a larger quantity of regularly reflected light, and if possible, all light.

### FIELD OF THE INVENTION

The present invention relates to an image forming apparatus which adopts an electrophotographic method, electrostatic printing method, or the like and, more particularly, to a photosensor mounted in an image forming apparatus which uses a belt member as a transfer medium convey belt or intermediate transfer belt and has a function of automatically correcting misregistration in forming multiple images.

### BACKGROUND OF THE INVENTION

There has been proposed an image forming apparatus capable of forming a color image by the following method. More specifically, this image forming apparatus comprises a plurality of image forming units which transfer toner images of respective colors onto a transfer sheet or intermediate transfer belt by irradiating a photosensitive drum serving as an image carrier with light that is emitted by a light-emitting element such as a laser or LED (Light Emitting Diode) and modulated in accordance with printing information, and by developing an electrostatic latent image formed on the photosensitive drum by an electrophotographic process. While a transfer sheet is sequentially conveyed by a transfer medium convey belt to the image forming units, toner images of respective colors are transferred onto the transfer sheet. Alternately, toner images of respective colors are transferred on the intermediate transfer belt, and then the toner images of the respective colors primarily transferred onto the intermediate transfer belt are transferred at once onto the transfer sheet.

In an image forming apparatus of this type, registration of color images formed on photosensitive drums may finally fail on a transfer medium subjected to multiple transfer due to the mechanical attachment error between the photosensitive drums, the optical path length error of each laser beam, changes in optical path, warpage of the LED caused by the ambient temperature, and the like.

To prevent this, as shown in FIG. 3A, an image misregistration detection pattern 3 formed from each photosensitive drum onto an intermediate transfer belt 31 is read by photosensors 2a and 2b to detect color misregistration on the photosensitive drum. A printing image signal is electrically corrected. Also, changes in optical path length or optical path are corrected by driving a deflection mirror inserted in the laser beam path.

Various patterns have been proposed as the image misregistration detection pattern 3. For example, Japanese Patent Laid-Open (KOKAI) Nos. 2000-098810 and 6-281572 propose a pattern comprised of the first line segment which is formed at a predetermined angle in a process direction serving as a transfer belt moving direction and the second line segment which is formed symmetrically to the first line segment via an imaginary line perpendicular to the process direction.

FIG. 3B shows a state in which the photosensors 2a and 2b detect the image misregistration detection pattern 3 on the intermediate transfer belt 31. The image misregistration detection pattern 3 is read by the photosensors 2a and 2b each of which is formed by an LED 4a serving as a light-emitting element and a phototransistor 4b serving as a light-receiving element. A pair of photosensors 2a and 2b are arranged at a predetermined distance in a direction perpendicular to the process direction. The image misregistration detection pattern 3 is so formed as to pass below the photosensors 2a and 2b.

The intermediate transfer belt 31 is formed by a material whose reflectance to light (e.g., infrared light) emitted by the LED 4a serving as a light-emitting element in the photosensor 2a or 2b is higher than the reflectance of the image misregistration detection pattern 3. The difference between the reflectances allows detecting the image misregistration detection pattern 3.

FIG. 4 shows a light-receiving circuit 17 which converts an output signal into an electrical signal when light emitted by the LED 4a is reflected by the image misregistration detection pattern 3 or intermediate transfer belt 31 and reflected light is received by the phototransistor 4b serving as a light-receiving element.

In FIGS. 3A, 3B, and 4, when the photosensors 2a and 2b detect a portion of the intermediate transfer belt 31, the reflected light quantity becomes large, and a large photocurrent flows through the phototransistor 4b. The photocurrent is converted into a voltage by a resistor 5, and the voltage is amplified by resistors 6, 7, and 8 and an operational amplifier 9.

When the photosensors 2a and 2b detect the image misregistration detection pattern 3, the reflected light quantity is small, and a photocurrent smaller than that for a portion of the intermediate transfer belt 31 flows through the phototransistor 4b. Similarly, the photocurrent is converted into a voltage by the resistor 5, and the voltage is amplified by the resistors 6, 7, and 8 and the operational amplifier 9.

FIG. 5 shows a state in which the light-receiving circuit 17 detects reflected light in an order of a portion of the intermediate transfer belt 31→the image misregistration detection pattern 3→a portion of the intermediate transfer belt 31. In FIG. 5, a threshold level Vt is set between a transfer belt detection level Va at which the intermediate transfer belt 31 is detected by the photosensors 2a and 2b, and a pattern detection level Vb at which the image misregistration detection pattern 3 is detected.

The threshold level Vt is set by a variable resistor 18 shown in FIG. 4. A comparator 19 compares a voltage value output from the operational amplifier 9 after converting a photocurrent flowing through the phototransistor 4b into a voltage, and the voltage value of the threshold level Vt set by the variable resistor 18, thereby generating a pattern detection output 28 shown in FIG. 5.

Sequentially supplied pattern detection outputs 28 are read to detect misregistration from, e.g., the width and interval of the image misregistration detection pattern 3. A printing image signal is electrically corrected. Further, changes in optical path length or optical path are corrected by driving a deflection mirror inserted in the laser beam path.

To precisely detect color misregistration by a photosensor, reflected light of light which irradiates an intermediate printing medium must be efficiently received, and the rise and fall times of a sensor output must be shortened. For this purpose, an arrangement in which light is focused on a light-receiving element or the use of a CCD for a light-receiving element are conceivable. However, this increases the cost.

There is also developed an arrangement in which a low-cost sensor using no lens or CCD is arranged and light is focused by pinholes equal in size between the light-emitting side and the light-receiving side to decrease the spot diameter of light emission. However, the influence of diffused light appears on the pattern detection output waveform as shown in FIG. 11A depending on the material of the intermediate transfer belt, resulting in low detection precision.

### SUMMARY OF THE INVENTION

It is an object of the present invention to provide a low-cost, high-precision sensor which adopts an arrangement of increasing the detection precision without using any lens or CCD, can suppress the influence of diffused light, and can be easily attached without any strict attachment precision.

To achieve the above object, according to the first aspect of the present invention, there is provided an image information detection sensor comprising a light-emitting element, a light-emitting pinhole which focuses light from the light-emitting element as detection light in a toner image detection region without using a lens, a light-receiving pinhole which transmits the detection light reflected in the toner image detection region, and a light-receiving element which receives the detection light having passed through the light-receiving pinhole, wherein a hole diameter of the light-receiving pinhole is set larger than a spot diameter of the detection light focused by the light-emitting pinhole.

This arrangement can detect an accurate pattern width and interval at low cost, and realize higher-precision registration correction. The production process can also be simplified.

The above and other objects, features, and advantages of the invention will become more apparent from the following detailed description taken in conjunction with the accompanying drawings.

### BRIEF DESCRIPTION OF THE DRAWINGS

FIG. 1 is a sectional view showing the arrangement of an image forming apparatus according to the present invention;

FIG. 2 is a block diagram showing the arrangement of the control unit of the image forming apparatus in FIG. 1;

FIGS. 3A and 3B are schematic sectional and plan views, respectively, showing a state in which an image misregistration detection pattern on a belt member is read by a photosensor in the image forming apparatus;

FIG. 4 is a circuit diagram showing the arrangement of a light-receiving circuit which receives an output from the photosensor;

FIG. 5 is a view showing an output from the photosensor and a pattern detection output from the light-receiving circuit when the image misregistration detection pattern is read;

FIG. 6 is a view showing an example of the image misregistration detection pattern formed on the belt member;

FIG. 7 is a timing chart when image misregistration detection pattern data is stored;

FIG. 8 is a view showing the arrangement of a pattern width position storage unit;

FIG. 9 is a flow chart for explaining registration correction operation;

FIGS. 10A and 10B are views showing the photosensor according to the present invention;

FIGS. 11A to 11D are views showing the detection waveform according to the present invention;

FIGS. 12A and 12B are conceptual views showing the read area and spot diameter according to the present invention;

FIG. 13 is a graph showing an output waveform when the hole diameter on the light-receiving side is smaller than that on the light-emitting side; and

FIG. 14 is a graph showing an output waveform when the hole diameter on the light-receiving side is larger than that on the light-emitting side.

### DETAILED DESCRIPTION OF THE PREFERRED EMBODIMENTS

The present invention will now be described in detail below with reference to the drawings showing a preferred embodiment thereof. In the drawings, elements and parts which are identical throughout the views are designated by identical reference numeral, and duplicate description thereof is omitted.

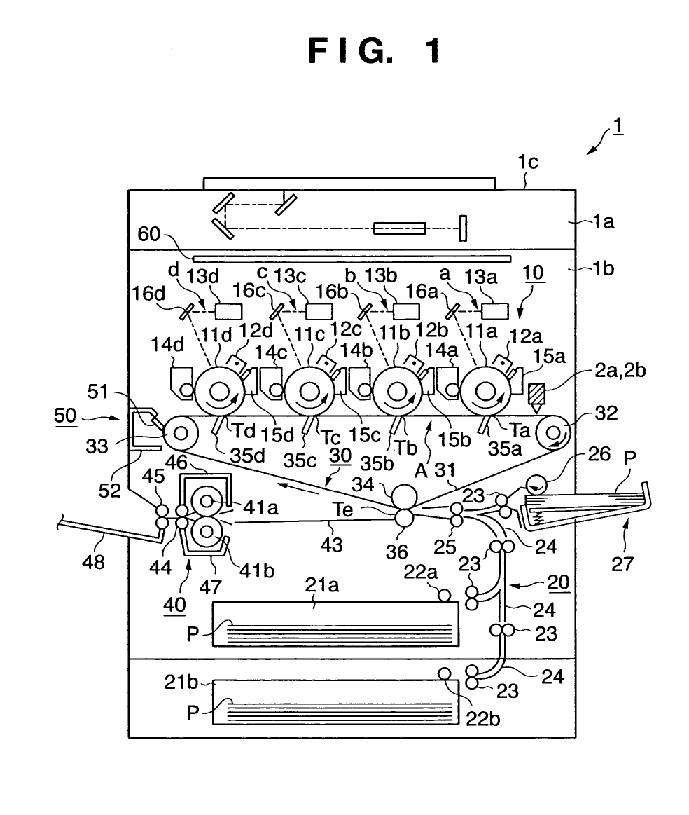

FIG. 1 is a schematic sectional view showing the arrangement of an image forming apparatus according to the first embodiment of the present invention. An image forming apparatus 1 employs electrophotography, and is configured as a so-called tandem color image output apparatus by arranging a plurality of image forming units side by side. The image forming apparatus 1 includes an image reading section 1a and image output section 1b. The image reading section 1a optically reads the document image of a document which is set on a platen glass 1c or conveyed by an automatic document feeder (not shown). The image reading section 1a converts the read image into an electrical signal, and supplies the electrical signal to the image output section 1b.

The image output section 1b is roughly comprised of image forming units 10 in which four stations a, b, c, and d with the same arrangement are arranged side by side, a feed unit 20 which feeds transfer media P stored in sheet feed cassettes 21a and 21b and a manual feed tray 27, an intermediate transfer unit 30 which secondarily transfers onto a transfer medium P a toner image primarily transferred onto an intermediate transfer belt 31 serving as a belt member and intermediate transfer body in the stations a, b, c, and d, a fixing unit 40 which fixes the toner image secondarily transferred onto the transfer medium P, a cleaning unit 50 which cleans toner left on the intermediate transfer belt 31, and a control unit 60 which comprehensively controls these units.

In the image forming units 10, photosensitive drums 11a, 11b, 11c, and 11d serving as image carriers are axially supported at their centers, and rotated and driven in directions indicated by arrows in FIG. 1. Primary chargers 12a, 12b, 12c, and 12d, optical systems 13a, 13b, 13c, and 13d, deflection mirrors 16a, 16b, 16c, and 16d, developing devices 14a, 14b, 14c, and 14d, and cleaning devices 15a, 15b, 15c, and 15d are arranged in the rotational directions of the photosensitive drums 11a to 11d so as to face the outer surfaces of the photosensitive drums 11a to 11d.

The primary chargers 12a to 12d charge the surfaces of the photosensitive drums 11a to 11d by a uniform charging amount. The optical systems 13a to 13d expose the surfaces of the photosensitive drums 11a to 11d to rays such as laser beams modulated in accordance with printing image signals, thereby forming electrostatic latent images on these surfaces. The electrostatic latent images are visualized by supplying toners of respective colors from the developing devices 14a to 14d which respectively store developers (to be referred to as “toners” hereinafter) of four, yellow, cyan, magenta, and black colors. On the downstream sides of primary transfer regions Ta, Tb, Tc, and Td where the visualized images are transferred onto the intermediate transfer belt 31 serving as an intermediate transfer body, the cleaning devices 15a, 15b, 15c, and 15d scrape toners which are not transferred onto the intermediate transfer belt 31 and remain on the photosensitive drums 11a to 11d, thereby cleaning the surfaces of the photosensitive drums 11a to 11d. By this image forming process, images are sequentially formed with the color toners.

Misregistration of the color toners on the intermediate transfer belt is detected using photosensors 2a and 2b, and registration correction is performed on the basis of the detection result. The detailed arrangement of the photosensor will be described later.

The feed unit 20 comprises the sheet feed cassettes 21a and 21b and manual feed tray 27 for storing transfer media P, pickup rollers 22a, 22b, and 26 for feeding transfer media P one by one from the sheet feed cassette 21a or 21b or manual feed tray 27, a pair of feed rollers 23 and feed guide 24 for conveying the transfer medium P fed by the pickup roller 22a, 22b, or 26 to a pair of registration rollers 25, and the pair of registration rollers 25 for feeding the transfer medium P to a secondary transfer region Te in synchronism with the image forming timing of the image forming unit 10.

The arrangement of the intermediate transfer unit 30 will be explained in detail. The intermediate transfer belt 31 serving as a belt member is formed by PET (polyethylene terephthalate), PVdF (polyvinylidene fluoride), or the like. The intermediate transfer belt 31 is looped between a driving roller 32 which transmits a rotation driving force to the intermediate transfer belt 31, a tension roller 33 which applies a proper tension to the intermediate transfer belt 31 by biasing of a spring (not shown) or the like, and a driven roller 34 which faces the secondary transfer region Te via the intermediate transfer belt 31. The intermediate transfer belt 31 has a primary transfer plane A between the driving roller 32 and the tension roller 33. The driving roller 32 prevents any slip of the intermediate transfer belt 31 by coating the surface of a metal roller with rubber (e.g., polyurethane rubber or chloroprene rubber) to a thickness of several mm. The driving roller 32 is rotated and driven by a pulse motor (not shown).

Primary transfer chargers 35a, 35b, 35c, and 35d are arranged on the lower surface side of the intermediate transfer belt 31 in the primary transfer regions Ta to Td where the photosensitive drums 11a to 11d face the intermediate transfer belt 31.

A secondary transfer roller 36 is so arranged as to face the driven roller 34 via the intermediate transfer belt 31. The nip on the intermediate transfer belt 31 between the rollers 36 and 34 forms the secondary transfer region Te. The secondary transfer roller 36 is pressed at a proper pressure against the intermediate transfer belt 31 serving as a belt member and intermediate transfer body. The cleaning unit 50 for cleaning an image forming surface on the intermediate transfer belt 31 is arranged, on the intermediate transfer belt 31, downstream of the secondary transfer region Te in the rotational direction. The cleaning unit 50 comprises a cleaning blade 51 which abuts against the surface of the intermediate transfer belt 31, and a waste toner box 52 which stores residual toner scraped by the cleaning blade 51.

The fixing unit 40 comprises a fixing roller 41a which incorporates a heat source such as a halogen heater, a press roller 41b which is pressed against the fixing roller 41a (note that the press roller 41b may also incorporate a heat source), a convey guide 43 for guiding the transfer medium P to the nip between the pair of rollers 41a and 41b, fixing/heat-insulating covers 46 and 47 for internally confining heat of the fixing unit 40, a pair of inner discharge rollers 44 and a pair of outer discharge rollers 45 for guiding the transfer medium P discharged from the pair of rollers 41a and 41b to outside the image forming apparatus 1, and a discharge tray 48 which supports the transfer medium P discharged outside the apparatus.

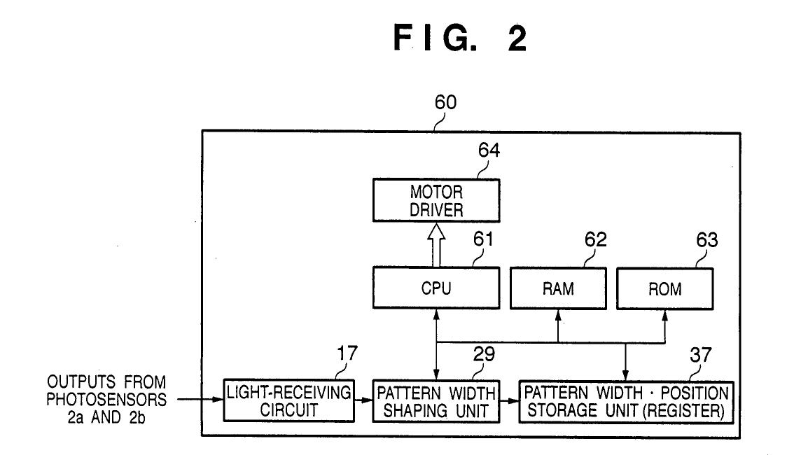

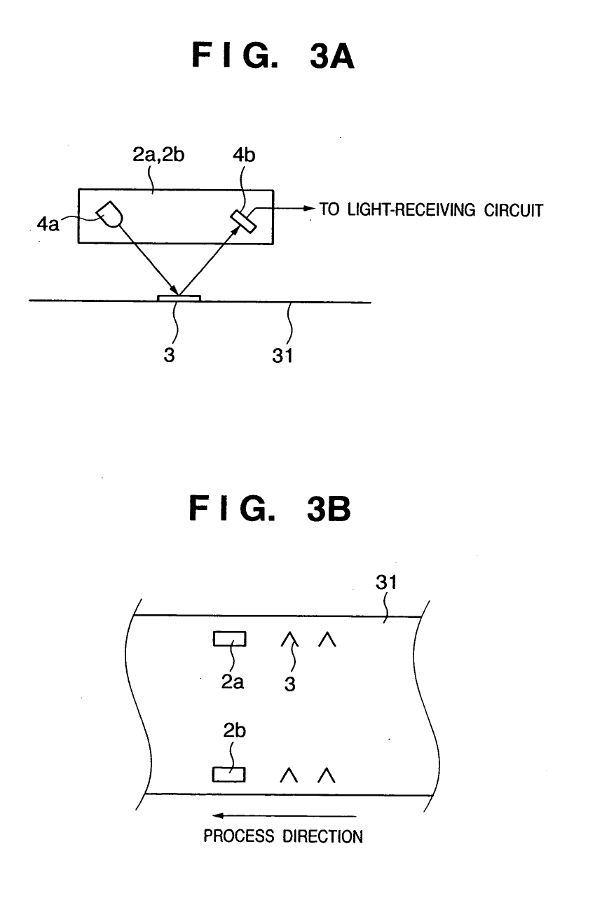

The control unit 60 will be described with reference to FIG. 2. The control unit 60 comprises a CPU (Central Processing Unit) 61 for controlling the image output section 1b, a RAM (Random Access Memory) 62 which stores control programs and data, a ROM (Read Only Memory) 63, and a motor driver 64 which drives various motors. The control unit 60 further comprises a light-receiving circuit 17 which receives outputs from the photosensors 2a and 2b shown in FIGS. 3A and 3B (to be described in detail later) and converts them into a waveform processible by a pattern width shaping unit 29, the pattern width shaping unit 29 which receives an output from the light-receiving circuit 17 and shapes the pattern width of an image misregistration detection pattern 3, and a pattern width position storage unit (register) 37 for storing the pattern width and position of the image misregistration detection pattern 3. Details of the control unit 60 will be described later.

Image forming operation of the image forming apparatus 1 will be explained in detail. When the CPU 61 generates an image forming operation start signal, feed operation starts from a feed means (the sheet feed cassette 21a or 21b or the manual feed tray 27) selected in accordance with the paper size of a selected transfer medium P or the like.

Assume that transfer media P are fed from the upper feed means shown in FIG. 1. Transfer media P are fed one by one from the sheet feed cassette 21a by the pickup roller 22a. Each transfer medium P is guided through the feed guide 24 by the pair of feed rollers 23, and conveyed to the pair of registration rollers 25. At this time, the pair of registration rollers 25 stop, and the leading end of the transfer medium P abuts against the nip between the pair of registration rollers 25. The pair of registration rollers 25 start rotating in synchronism with a timing when the image forming unit 10 starts forming an image. The rotation timing of the pair of registration rollers 25 is set such that a toner image primarily transferred onto the intermediate transfer belt 31 by the image forming unit 10 and the transfer medium P coincide with each other in the secondary transfer region Te.

In the image forming unit 10, when the CPU 61 generates an image forming operation start signal, a toner image formed by the above-described image forming process on the photosensitive drum 11d located on the uppermost stream side in the rotational direction of the intermediate transfer belt 31 is primarily transferred onto the intermediate transfer belt 31 in the primary transfer region Td by the primary transfer charger 35d to which a high voltage is applied. The primarily transferred toner image is conveyed to the next primary transfer region Tc. In the primary transfer region Tc, an image is formed with a delay corresponding to the convey time of the toner image between the image forming units 10. The next toner image is registered to the previous toner image and transferred onto it. The same process is subsequently repeated, and as a result, toner images of the four colors are sequentially primarily transferred onto the intermediate transfer belt 31.

The transfer medium P enters the secondary transfer region Te, and comes into contact with the intermediate transfer belt 31. A high voltage is applied to the secondary transfer roller 36 in synchronism with the pass timing of the transfer medium P. The toner images of the four colors formed on the intermediate transfer belt 31 by the above-mentioned image forming process are transferred onto the surface of the transfer medium P. Thereafter, the transfer medium P is accurately guided by the convey guide 43 to the nip between the fixing roller 41a and the press roller 41b. The toner image is fixed onto the surface of the transfer medium P by the heat of the pair of rollers 41a and 41b and the nip pressure. The transfer medium P is conveyed by the pair of inner discharge rollers 44 and the pair of outer discharge rollers 45, discharged outside the apparatus, and stacked on the discharge tray 48.

FIGS. 3A and 3B show a state in which the photosensors 2a and 2b detect the image misregistration detection pattern 3 on the intermediate transfer belt 31. As shown in FIG. 3A, the image misregistration detection pattern 3 is read by the photosensors 2a and 2b each of which is formed by a light-emitting element and light-receiving element such as an LED 4a and phototransistor 4b. That is, each of the photosensors 2a and 2b has the LED 4a serving as a light-emitting element and the phototransistor 4b serving as a light-receiving element. Each of the photosensors 2a and 2b is so configured as to output a signal when a reflected light quantity received by the phototransistor 4b after light emitted by the LED 4a is reflected by the intermediate transfer belt 31 serving as a belt member looped, rotated, and driven near the photosensitive drums 11a to 11d serving as image forming units exhibits a predetermined value or more.

As shown in FIG. 3B, a pair of photosensors 2a and 2b are arranged at a predetermined distance in a direction perpendicular to the process direction. The image misregistration detection pattern 3 is so formed as to pass above the photosensors 2a and 2b.

The intermediate transfer belt 31 is formed by a material whose reflectance to light (e.g., infrared light) emitted by the LED 4a serving as a light-emitting element in the photosensor 2a or 2b is higher than the reflectance of the image misregistration detection pattern 3. The difference between the reflectances allows detecting the image misregistration detection pattern 3.

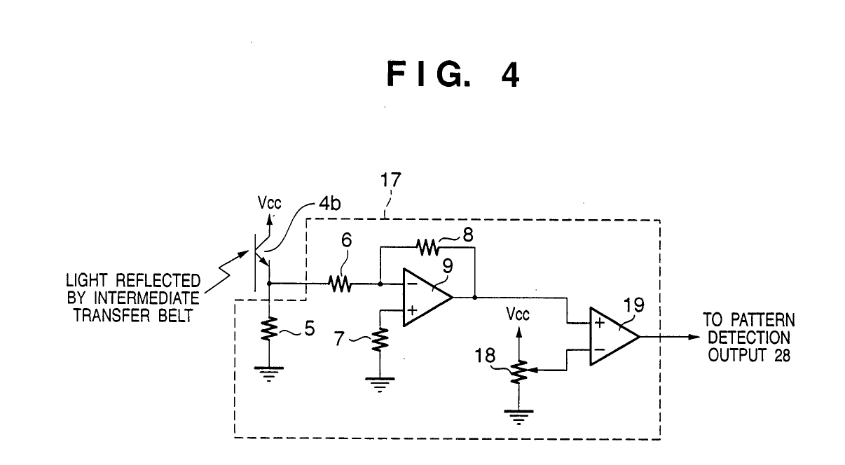

FIG. 4 shows the light-receiving circuit 17 which converts an output signal into an electrical signal when light emitted by the LED 4a is reflected by the image misregistration detection pattern 3 or intermediate transfer belt 31 and reflected light is received by the phototransistor 4b serving as a light-receiving element. In FIGS. 3A, 3B, and 4, when the photosensors 2a and 2b detect a portion of the intermediate transfer belt 31, the reflected light quantity becomes large, and a large photocurrent flows through the phototransistor 4b. The photocurrent is converted into a voltage by a resistor 5, and the voltage is amplified by resistors 6, 7, and 8 and an operational amplifier 9. When the photosensors 2a and 2b detect the image misregistration detection pattern 3, the reflected light quantity is small, and a photocurrent smaller than that for a portion of the intermediate transfer belt 31 flows through the phototransistor 4b. Similarly, the photocurrent is converted into a voltage by the resistor 5, and the voltage is amplified by the resistors 6, 7, and 8 and the operational amplifier 9.

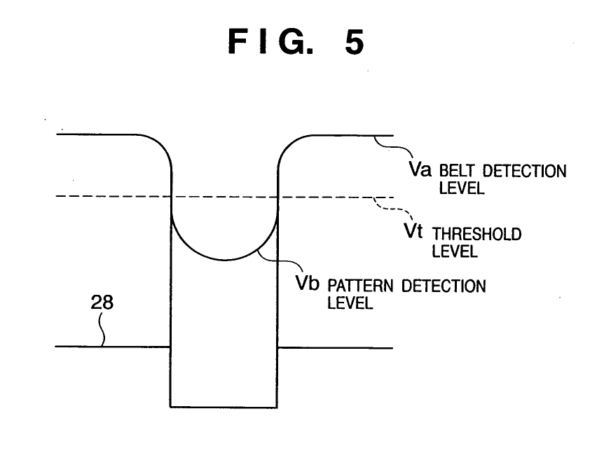

FIG. 5 shows a state in which the light-receiving circuit 17 detects reflected light in an order of a portion of the intermediate transfer belt 31→the image misregistration detection pattern 3→a portion of the intermediate transfer belt 31. A threshold level Vt is set between a transfer belt detection level Va at which the intermediate transfer belt 31 is detected by the photosensors 2a and 2b, and a pattern detection level Vb at which the image misregistration detection pattern 3 is detected.

The threshold level Vt is set by a variable resistor 18 shown in FIG. 4. A comparator 19 compares a voltage value output from the operational amplifier 9 after converting a photocurrent flowing through the phototransistor 4b into a voltage, and the voltage value of the threshold level Vt set by the variable resistor 18, thereby generating a pattern detection output signal 28. Sequentially supplied pattern detection output signals 28 are read to detect misregistration from, e.g., the width and interval of the image misregistration detection pattern 3. A printing image signal is electrically corrected. Further, changes in optical path length or optical path are corrected by driving a deflection mirror inserted in the laser beam path.

Registration correction operation will be explained.

Registration correction operation starts in response to an instruction from the CPU 61. When the image misregistration detection pattern 3 is detected, an output signal is converted into an electrical signal by the photosensors 2a and 2b shown in FIGS. 3A and 3B and the light-receiving circuit 17 shown in FIG. 4. The electrical signal is then input to the pattern width shaping unit 29. The pattern width shaping unit 29 controls to remove chattering of an output from the light-receiving circuit 17, prevent a detection error caused by a scratch on the intermediate transfer belt 31, and store the pattern width and pattern position in the pattern width position storage unit (register) 37. Based on the data stored in the pattern width position storage unit 37, misregistration values on the photosensitive drums 11a to 11d corresponding to respective colors are calculated using the CPU 61, a table stored in the ROM 63 and the like. A printing image signal is electrically corrected. The motor which controls the deflection mirrors 16a to 16d is driven and controlled by the motor driver 64 to control the deflection mirrors 16a to 16d inserted in the laser beam path, thereby correcting changes in optical path length or optical path.

In the first embodiment, the photosensitive drums 11a to 11d serving as a plurality of image forming means for forming an image also function as pattern forming means for forming the image misregistration detection pattern 3 for correcting errors of images formed by the photosensitive drums 11a to 11d. The pattern detection means for detecting the image misregistration detection pattern 3 adopts photosensors with the arrangement shown in FIGS. 3A and 3B, and a detailed arrangement will be described later.

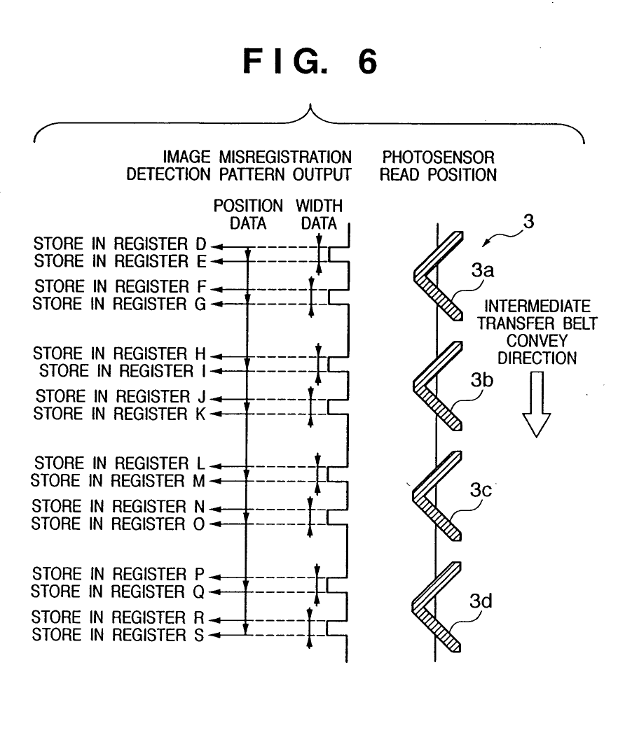

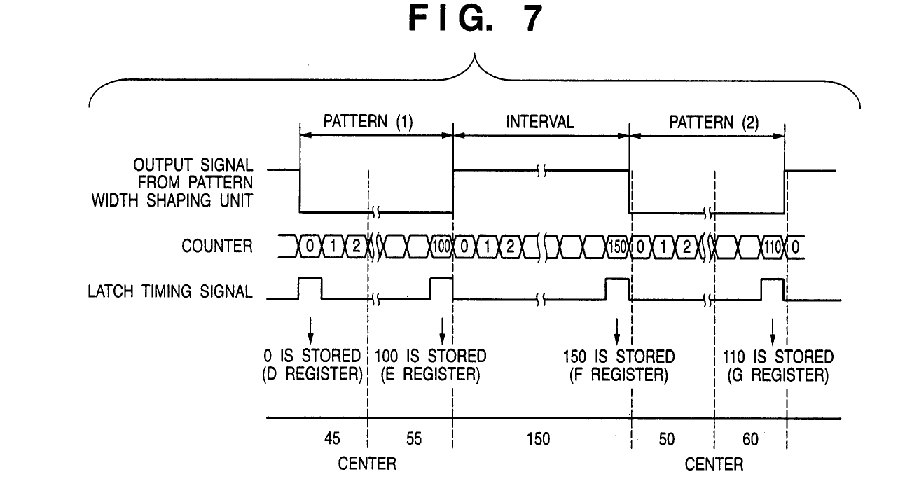

Detection of the image misregistration detection pattern 3 and the data storage timing in the pattern width position storage unit (register) 37 will be explained with reference to FIGS. 6 and 7. The counter operates on the basis of a pattern width shaping unit output signal obtained by the pattern width shaping unit 29 shown in FIG. 2. A latch timing signal is generated, and data is stored in the pattern width position storage unit (register) 37.

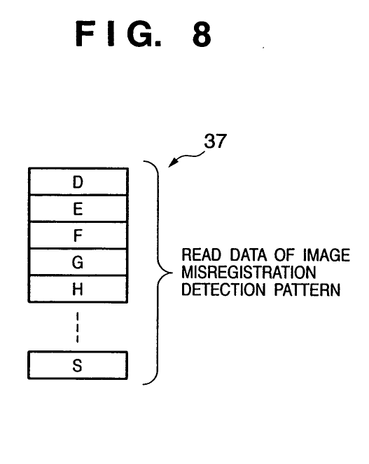

For example, when the image misregistration detection pattern 3 as shown in FIG. 6 provides signals as shown in FIG. 7, the D register of the pattern width·position storage unit 37 shown in FIG. 8 stores a counter value “0”. Subsequently, registers store counter value data such that the E register stores “100”, the F register stores “150”, the G register stores “110”, . . . Accordingly, the pattern width and pattern interval of the image misregistration detection pattern 3 can be detected, and an absolute position from the first detected signal can be obtained.

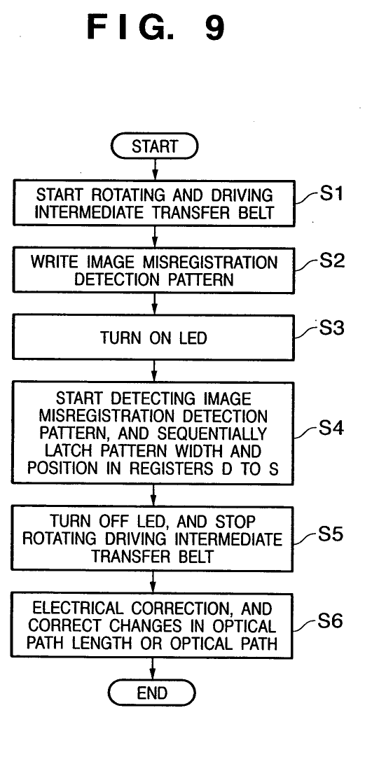

A registration correction operation sequence by a registration correction means for correcting registration of the photosensitive drums 11a to 11d serving as image forming means on the basis of the detection result of the pattern width shaping unit 29 serving as the above-mentioned pattern detection means will be explained with reference to FIG. 9.

The CPU 61 shown in FIG. 2 executes registration correction operation at a timing when an image can be formed upon powering on the image forming apparatus 1 or a predetermined time after power-on. When registration correction operation starts, the intermediate transfer belt 31 is rotated and driven in step S1 shown in FIG. 9. In step S2, write of the image misregistration detection pattern 3 on the intermediate transfer belt 31 starts by the photosensitive drums 11a to 11d. Before the image misregistration detection pattern 3 written on the intermediate transfer belt 31 passes above the photosensors 2a and 2b, the LED 4a is turned on (step S3), and detection operation of the image misregistration detection pattern 3 starts in step S4. In step S4, as described above, signals from the photosensors 2a and 2b are supplied to the light-receiving circuit 17 and the pattern width shaping unit 29 which shapes the pattern width of the image misregistration detection pattern 3. This processing removes a detection error signal generated by a scratch, dust, or the like. The pattern width and position of the image misregistration detection pattern 3 are sequentially stored in the registers D to S of the pattern width position storage unit 37.

In step S5, the LED 4a is turned off, and rotation/driving of the intermediate transfer belt 31 stops, ending pattern width/interval detection operation. The flow advances to step S6 to electrically correct a printing image signal on the basis of data stored in the registers D to S, a table stored in the ROM 63, and the like. Also, the deflection mirrors 16a to 16d inserted in the laser beam path are driven to correct changes in optical path length or optical path, ending registration correction operation.

For example, FIG. 6 shows a state in which the image misregistration detection pattern 3 is stored when it is read. The registers D, E, F, and G store the position data and width data of an image misregistration detection pattern 3a on the basis of an image misregistration detection pattern output obtained by reading the image misregistration detection pattern 3a by the photosensors 2a and 2b. Similarly, the registers H to S store the position data and width data of image misregistration detection patterns 3b to 3d on the basis of image misregistration detection pattern outputs obtained by reading the image misregistration detection patterns 3b to 3d by the photosensors 2a and 2b. The first embodiment has described registration correction in an intermediate transfer method (batch transfer method) by the intermediate transfer belt 31 on which images are formed by the photosensitive drums 11a to 11d serving as image forming means. This registration correction is also effective for a multi-transfer method by a transfer medium convey belt serving as a transfer medium convey means for conveying the transfer medium P on which an image is formed by the image forming means.

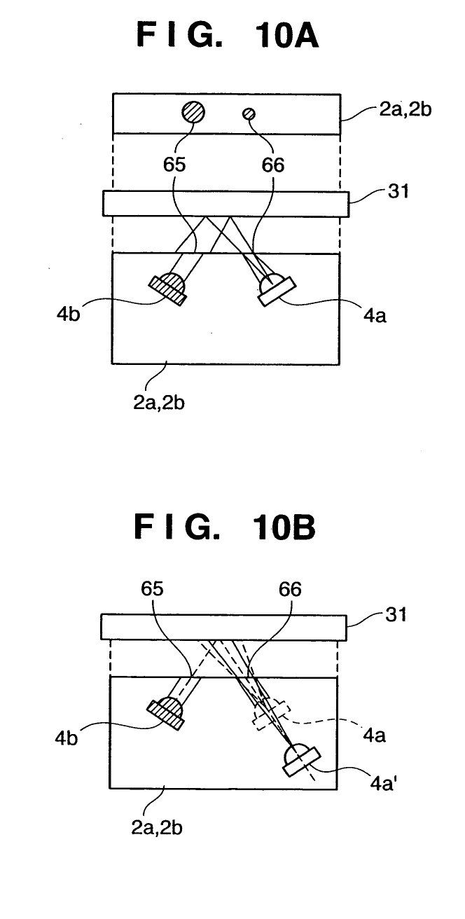

The detailed arrangement of the photosensor which is a characteristic feature of the first embodiment will be explained with reference to FIGS. 10A, 10B, 11A to 11D, 12A, and 12B. In the first embodiment, LEDs are used as light-emitting elements 4a and 4a′, and a phototransistor is used as the light-receiving element 4b. Light emitted by the LED diverges, but the spot diameter on the belt must be made small in order to precisely detect image information on the intermediate transfer belt 31. For this purpose, the prior art employs an arrangement in which a light-receiving element can detect all regularly reflected light by using a lens. The use of the lens increases the development cost and factory adjustment cost. To suppress the cost, according to the first embodiment, light emitted by the LED is focused by a pinhole 66 without using any lens, and light passing through a pinhole 65 is received. This eliminates the need for strict attachment precision, facilitates the attachment process in the factory, and achieves cost reduction.

The hole diameters of pinholes on the light-emitting side and light-receiving side will be considered on the basis of experimental examples.

1. Case in which Hole Diameter of Pinhole is Equal Between Light-Emitting Side and Light-Receiving Side

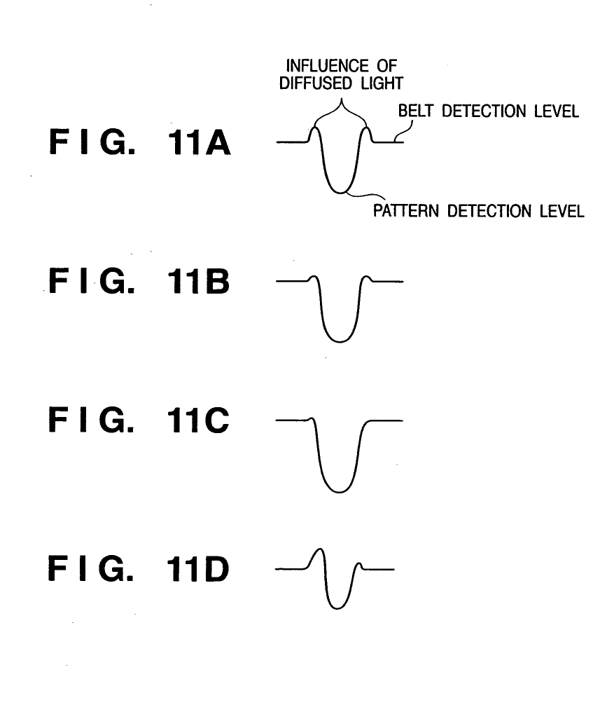

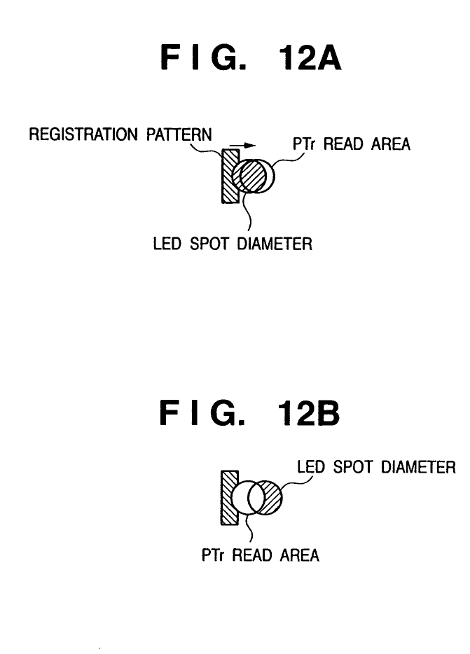

The hole diameters of the pinholes on the light-emitting side and light-receiving side are equally set to Φ2. If the optical axis slightly shifts as shown in FIG. 12A, the waveform is influenced not only by regularly reflected light but also by diffused/reflected light on toner. This causes an overshoot on the read end side. Similarly, a shift as shown in FIG. 12B causes an overshoot on the read start side. The overshoot leads to an output waveform as shown in FIG. 11D. The fall and rise edges have different inclinations, and the registration pattern detection precision decreased.

2. Case in which Hole Diameter on Light-Receiving Side is Smaller than that on Light-Emitting Side

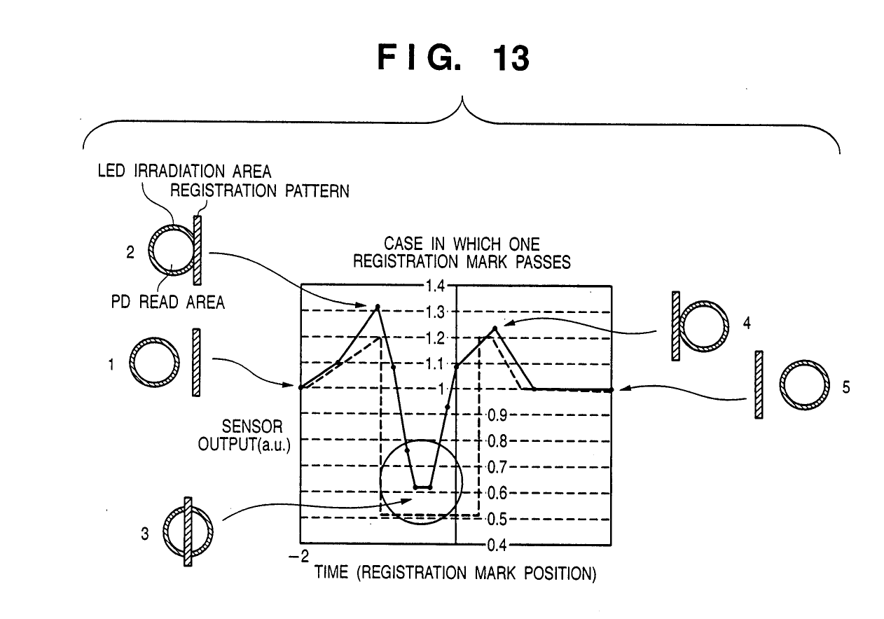

A waveform as shown in FIG. 13 is obtained when the hole diameter of the pinhole on the light-receiving side is set smaller than that on the light-emitting side by setting Φ2 on the light-emitting side and Φ1.5 on the light-receiving side. Each number represents the relationship between the waveform and the positional relationship between the registration pattern, the LED irradiation area, and the PD read area. For Nos. 2 and 4, the waveform is influenced by diffused/reflected light. The fall and rise edges have different inclinations, and the registration pattern detection precision decreases, as represented by ●. In other words, all regularly reflected light cannot be received, and the regularly reflected light quantity decreases. No sufficient dynamic range can be attained depending on the material of the intermediate transfer belt 31. In addition, diffused light is detected from a pattern of a toner other than Bk toner, as shown in FIG. 11A. A detection output from the pattern unit increases, widening the difference from a detection output for Bk toner. A relative difference is generated in pattern width detection between Bk and the remaining colors, resulting in low detection precision. A waveform as shown in FIG. 11D may be output depending on the optical axis shift, and the detection precision deteriorates, as described above.

In order to obtain high detection precision, the edge of the detection waveform must be steep, and the fall and rise inclinations must be equal between colors. For this purpose, the spot diameter of the LED must be reduced. In the first embodiment, the spot diameter is reduced not by a lens but by a pinhole. Only light having passed through the pinhole is used for detection, and the light quantity decreases. To avoid this, according to the first embodiment, the spot diameter of the LED is reduced by minimizing the hole diameter of the pinhole 66 on the light-emitting side as far as a satisfactory detection level can be obtained, as shown in FIG. 10A. Further, the hole diameter of the pinhole 65 on the light-receiving side is set larger than that on the light-emitting side-so as to receive a larger quantity of regularly reflected light, and if possible, all light.

3. Case in which Hole Diameter on Light-Receiving Side is Larger than that on Light-Emitting Side

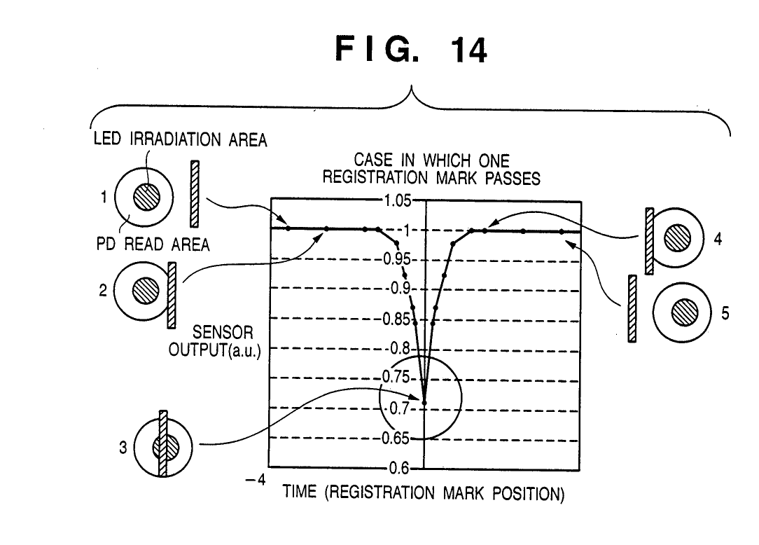

A waveform as shown in FIG. 14 is obtained when the hole diameter of the pinhole on the light-receiving side is set larger than that on the light-emitting side by setting Φ1.5 on the light-emitting side and Φ4 on the light-receiving side. Each number represents the relationship between the waveform and the positional relationship between the registration pattern, the LED irradiation area, and the PD read area. Even for Nos. 2 and 5, the waveform is not influenced by diffused/reflected light. The fall and rise edges exhibit the same inclination without any overshoot, and the registration pattern detection precision increases, as represented by ●.

With this arrangement, the influence of diffused light by a small optical axis shift as shown in FIG. 11A can be eliminated, as shown in FIG. 14, or can be relatively decreased, as shown in FIG. 11B. Image information can be detected at high precision.

The second embodiment will be explained.

The arrangement is the same as that of the first embodiment except FIG. 10B, and a description thereof will be omitted.

In the second embodiment, LEDs are used as light-emitting elements 4a and 4a′, and a phototransistor is used as a light-receiving element 4b. Light emitted by the LED diverges, but the spot diameter on the belt must be made small in order to precisely detect image information on an intermediate transfer belt 31. Thus, the prior art employs an arrangement in which a light-receiving element can detect all regularly reflected light by using a lens. In the second embodiment, light emitted by the LED is narrowed down by a pinhole 66, and light passing through a pinhole 65 is received.

When the hole diameter of the pinhole is equal between the light-emitting side and the light-receiving side, the waveform is influenced not only by regularly reflected light but also by diffused/reflected light on toner due to a small optical axis shift, decreasing the registration pattern detection precision. When the hole diameter of the pinhole 65 on the light-receiving side is smaller than that of the pinhole 66 on the light-emitting side, all regularly reflected light cannot be received, and the regularly reflected light quantity decreases. No sufficient detection precision can be obtained depending on the material of the intermediate transfer belt 31.

In order to obtain high detection precision, the edge of the detection waveform must be steep, and the spot diameter of the LED must be reduced. In the second embodiment, the spot diameter is reduced not by a lens but by a pinhole. The hole diameter of the pinhole is physically limited, and may not decrease the spot diameter of the LED to a desired size.

Considering this, the second embodiment moves the LED element (4a′) backward along the optical axis, as shown in FIG. 10B. As a result, the spot diameter of the LED on the intermediate transfer belt 31 can be satisfactorily reduced without changing the hole diameter of the pinhole 66.

With this arrangement, the influence of diffused light by a small optical axis shift as shown in FIG. 11A can be relatively decreased, as shown in FIG. 11B. Image information can be detected at high precision.

Similar to the first embodiment, the hole diameter of the pinhole 65 on the light-receiving side is set larger than that on the light-emitting side, and the LED element (4a′) is moved backward along the optical axis. The influence of diffused light as shown in FIG. 11A can be further reduced, as shown in FIG. 11C, and image information can be detected at higher precision.

The same effects can also be attained by arranging the phototransistor serving as a light-receiving element close to the pinhole.

As many apparently widely different embodiments of the present invention can be made without departing from the spirit and scope thereof, it is to be understood that the invention is not limited to the specific embodiments thereof except as defined in the appended claims.

What is claimed is:

1. An image information detection sensor comprising:
a light-emitting element;
a light-emitting pinhole which focuses light from said light-emitting element as detection light in a toner image detection region without using a lens;
a light-receiving pinhole which transmits the detection light reflected in the toner image detection region; and
a light-receiving element which receives the detection light having passed through said light-receiving pinhole,
wherein a hole diameter of said light-receiving pinhole is set larger than a spot diameter of the detection light focused by said light-emitting pinhole.

2. The sensor according to claim 1, wherein the hole diameter of said light-receiving pinhole is set larger than a hole diameter of said light-emitting pinhole.

3. The sensor according to claim 1, wherein said light-emitting element is arranged more apart from said light-emitting pinhole in order to narrow down the spot diameter of the detection light focused in the toner image detection region.

4. The sensor according to claim 1, wherein the image information detection sensor does not have a lens for focusing the detection light in a region where the detection light passes between a toner image and said light-receiving element.

5. An image forming apparatus using an image information detection sensor defined in claim 1, comprising:
a plurality of image forming means; and
a belt member which is looped, rotated, and driven near said image forming means,
wherein in order to correct misregistration of an image formed by said plurality of image forming means, an image misregistration detection pattern which is formed by said plurality of image forming means and transferred onto said belt member is read by the image information detection sensor, and registration of each image forming means is corrected on the basis of a detection result.

6. The apparatus according to claim 5, wherein said belt member includes a transfer medium convey belt which conveys a transfer medium on which an image is formed by said image forming means.

7. The apparatus according to claim 5, wherein said belt member includes an intermediate transfer belt on which an image is formed by said image forming means.
